(19) United States
(12) Patent Application Publication
(10) Pub. No.: US 2007/0139630 A1
(43) Pub. Date: Jun. 21, 2007

(54) Changeable Slit to Control Uniformity of Illumination

(75) Inventors: John Kleman, Melissa, TX (US); Obie Rooker, Terrell, TX (US)

Correspondence Address: AKA CHAN LLP, 900 LAFAYETTE STREET, SUITE 710, SANTA CLARA, CA, 95050, US

(73) Assignee: NIKON PRECISION, INC., Belmont, CA (US)

(21) Appl. No.: 11/532,393

(22) Filed: Sep. 15, 2006

Related U.S. Application Data
(60) Provisional application No. 60/751,690, filed on Dec. 19, 2005.

(51) Int. Cl. G03B 27/42

(52) U.S. Cl. 355/53; 355/67

(57) ABSTRACT

Methods and apparatus for controlling illumination uniformity by altering the size of a slit are disclosed. According to one aspect of the present invention, an apparatus includes a light source, an exposure surface, and an illumination unit. The light source generates a beam that is projected onto the exposure surface. The illumination arrangement includes a first support surface and a first removable plate that is configured to be coupled to the first support surface. A first edge of the first removable plate and a second edge cooperate to at least partially define a slit through which the beam is projected.

### CROSS-REFERENCE TO RELATED APPLICATIONS

The present invention claims priority to co-pending U.S. Provisional Patent Application No. 60/751,690, filed Dec. 19, 2005, which is incorporated herein by reference in its entirety.

### BACKGROUND OF THE INVENTION

1. Field of Invention

The present invention relates generally to controlling illumination uniformity associated with lithography devices. More particularly, the present invention relates to a structure which allows the configuration of a slit in an illumination unit of a lithography system to be altered by changing a slit plate that defines at least an edge of the slit.

2. Description of the Related Art

For photolithography procedures which are used in the fabrication of semiconductors, the ability to control the procedures is important to ensure that semiconductors are accurately formed. By way of example, exposure processes which allow for the transfer of a circuit pattern from a reticle onto a wafer must be carefully controlled to ensure that the circuit pattern is accurately transferred onto a desired portion of the wafer. When the circuit pattern is not accurately transferred onto a desired portion of the wafer, the quality and the performance of semiconductors formed from the wafer may be compromised.

A laser beam generally passes through a reticle to transfer a circuit pattern from the reticle onto a wafer. To prevent the laser beam or light from passing through the reticle until after an appropriate area of the wafer is positioned under the reticle, reticle blinds are often used to shield the reticle from a laser until the wafer is properly positioned. When the reticle blinds are open to expose the wafer, an exposure field of the wafer may be exposed to the laser through a slit associated with an illumination unit. The use of a slit enables the portions of the exposure field that are exposed to the laser to be controlled. It should be appreciated that the size and shape of a slit is typically fixed. By way of example, a slit generally has straight sides and is approximately shaped as a rectangle.

While the use of slits is effective in controlling the portions of an exposure field that are to be exposed to a laser at any given time, fixed slits generally do not enable illumination uniformity or light distribution to be efficiently controlled. Fixed slits may not enable the area relative to a Y-direction at different positions across the slit relative to an X-position and, hence, may not allow uniformity control. Controlling illumination uniformity typically entails the use of a pattern filter, e.g., a random pattern filter, installed within an illumination unit. A random pattern filter is arranged to control illumination uniformity by correcting for second-order light effects using an optical approach. Objects are sputtered onto an optical plate, a process which is difficult, time consuming, and expensive to accomplish.

Although a random pattern filter is generally effective in controlling illumination uniformity, random pattern filters are specialized for each system, and are time-consuming as well as expensive to manufacture. Special random pattern filters may have to be designed to correct for different orders and tilt. In addition, random pattern filters typically may not be used more than once, and have a shelf life. Installing and uninstalling random pattern filters in an illumination unit is generally time-intensive. By way of example, the illumination unit may have to be disassembled in order for a new random pattern filter to be installed. Disassembling and reassembling the illumination unit causes the N2 purge of the overall illumination unit to be lost. Further, it is often difficult to accurately align a random pattern filter relative to a laser and a slit. Hence, the use of a random pattern filter may be impractical in many systems.

Therefore, what is desired is a method and an apparatus which allows illumination uniformity to be accurately controlled. That is, what is needed is a system which allows illumination uniformity to be efficiently controlled in a readily implemented, relatively inexpensive manner.

### BRIEF SUMMARY OF THE INVENTION

The present invention relates to utilizing a removable plate to define an edge of a slit in an illumination unit. According to one aspect of the present invention, an apparatus includes a light source, an exposure surface, and an illumination unit. The light source generates a beam that is projected onto the exposure surface. The illumination arrangement includes a first support surface and a first removable plate that is configured to be coupled to the first support surface. A first edge of the first removable plate and a second edge cooperate to at least partially define a slit through which the beam is projected.

In one embodiment, the illumination arrangement includes a lens and a mirror, and the slit is positioned between the lens and the mirror. In another embodiment, the first edge of the removable slit plate has a straight edge.

Allowing either or both the size and the shape of the slit to be varied or changed enables illumination uniformity to be controlled. The size or the shape of a slit may be inexpensively and efficiently altered by removing and replacing a plate that defines an edge of the slit. The use of plates with different sizes and shapes allows the overall size and the shape of a slit to be varied such that illumination uniformity may be varied. When one edge of a slit is changed, i.e., by replacing the removable slit plate that defines the edge of the slit, the slit is effectively redefined. Hence, changing the illumination uniformity associated with a lithography device such as a scanner, entails removing and replacing a removable slit plate.

According to another aspect of the present invention, a method for controlling illumination uniformity associated with a scanning apparatus with a first support surface, a second support surface, a source, and an exposure surface includes coupling a first removable slit plate to the first support surface. The first removable slit plate has a first edge that cooperates with a second edge of the second support surface to define a slit. The method also includes performing a scan, wherein performing the scan includes creating a beam using the source that passes through the slit to the exposure surface. A determination is made regarding whether the illumination uniformity associated with the scan is acceptable. If the illumination uniformity associated with the scan is not acceptable, the first removable slit plate is removed from the first support surface, and a second removable slit plate is coupled to the first support surface. The second removable slit plate has a third edge that cooperates with the second edge to define the slit in the absence of the first edge.

In one embodiment, the scanning apparatus includes a slit plate holder supported by the first support surface. In such an embodiment, the slit plate holder couples the first removable slit plate to the first support surface and alternatively couples the second removable slit plate to the first support surface in the absence of the first removable slit plate. In another embodiment, coupling the first removable slit plate to the first support surface includes magnetically coupling the first removable slit plate to the first support surface.

These and other advantages of the present invention will become apparent upon reading the following detailed descriptions and studying the various figures of the drawings.

### BRIEF DESCRIPTION OF THE DRAWINGS

The invention may best be understood by reference to the following description taken in conjunction with the accompanying drawings in which:

FIG. 1 is a block diagram representation of a lithography apparatus.

FIG. 2 is a block diagram representation of an illumination unit, e.g., illumination unit 112 of FIG. 1, which includes a changeable slit in accordance with an embodiment of the present invention.

FIG. 3A is a diagrammatic representation of an apparatus that defines a slit using a removable slit plate in accordance with an embodiment of the present invention.

FIG. 3B is a diagrammatic representation of an apparatus that defines a slit using a plurality of removable slit plates in accordance with an embodiment of the present invention.

FIG. 3C is a diagrammatic representation of an apparatus that defines a slit using a concave removable slit plate in accordance with an embodiment of the present invention.

FIG. 4 is a block diagram representation of an assembly that includes a slit plate in accordance with an embodiment of the present invention.

FIG. 5A is a diagrammatic front-view representation of an assembly that includes a slit plate in accordance with an embodiment of the present invention.

FIG. 5B is a diagrammatic cross-sectional side view representation of a first assembly that includes a slit plate in accordance with an embodiment of the present invention.

FIG. 5C is a diagrammatic cross-sectional side view representation of a second assembly that includes a slit plate in accordance with an embodiment of the present invention.

FIG. 6 is a process flow diagram which illustrates steps associated with one method of utilizing a changeable slit in accordance with an embodiment of the present invention.

FIG. 7 is a block diagram representation of an illumination path associated with a scanner in accordance with an embodiment of the present invention.

FIG. 8 is a diagrammatic representation of a changeable slit that is installed in a support apparatus in accordance with an embodiment of the present invention.

FIG. 9 is a diagrammatic representation of a photolithography apparatus in accordance with an embodiment of the present invention.

FIG. 10 is a process flow diagram which illustrates the steps associated with fabricating a semiconductor device in accordance with an embodiment of the present invention.

FIG. 11 is a process flow diagram which illustrates the steps associated with processing a wafer, i.e., step 1304 of FIG. 10, in accordance with an embodiment of the present invention.

### DETAILED DESCRIPTION OF THE INVENTION

Controlling the illumination uniformity of an exposure process allows a wafer and, hence, a semiconductor to be accurately formed as a result of the exposure process. Random pattern filters are often used as a part of an illumination unit to control illumination uniformity. The use of a random pattern filter to control illumination uniformity associated with a lithographic system, while effective, is generally complicated and expensive.

Within illumination systems, a slit is generally used to control the width of illumination or light projected through a reticle and onto an exposure field of a wafer. Allowing at least one of the size and the shape of the slit to be altered enables illumination uniformity to be controlled. The size or the shape of a slit may be varied by replacing a removable plate that defines an edge of the slit with a removable plate of a different size or shape. In one embodiment, a top of a changeable slit may be defined by a substantially fixed edge, while a bottom of the slit may be defined by an outside edge of a removable plate or blade. As such, when the removable plate is replaced, the bottom of the slit is effectively redefined.

A removable plate may be relatively inexpensive and uncomplicated to manufacture. An operator of a lithography device, e.g., a scanner, may stock a set of removable plates of various shapes and sizes such that he or she may have easy access to an appropriate plate for use to achieve a particular level of illumination uniformity. Different removable plates may be stocked to compensate for such factors as different orders and tilt. As removing and installing removable plates may be performed substantially without disassembling and then reassembling an illumination unit, the installation of a removable plate is relatively fast, and does not result in the overall illumination unit losing an N2 purge.

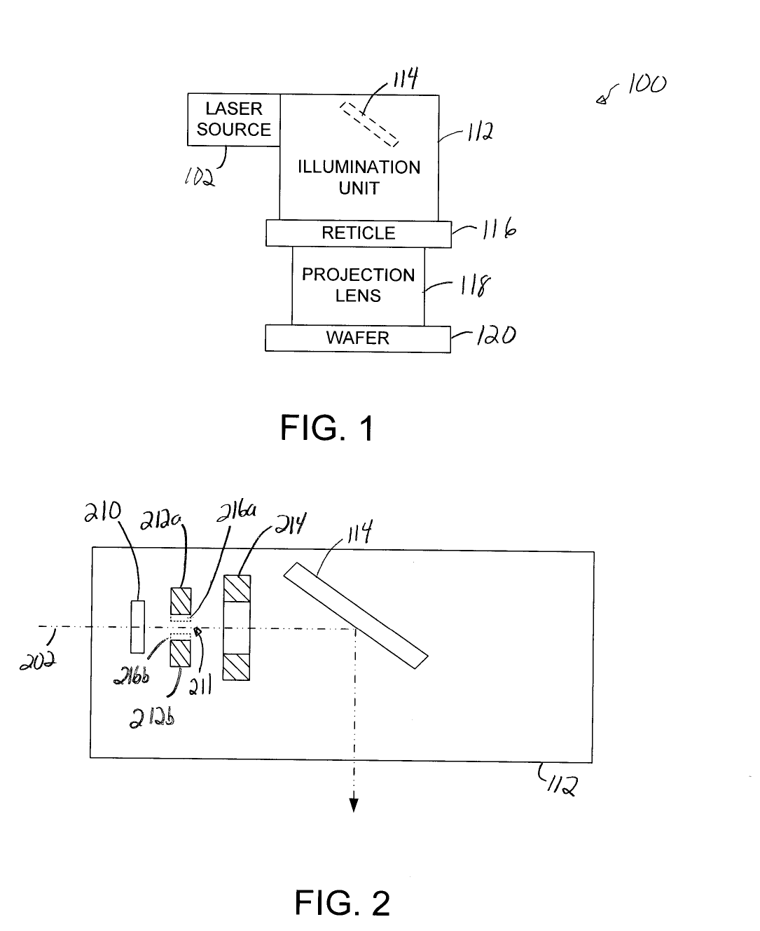

An illumination unit that includes a changeable slit that is at least partially defined by a removable slit plate is generally part of a lithography apparatus. FIG. 1 is a block diagram representation of a system that includes an illumination unit. A system 100, which may generally be a scanner or a scanning system, includes a laser source 102 that generates a laser beam that is arranged to pass through an illumination unit 112. Illumination unit 112 may include at least one mirror 114 that is arranged to cause an incident laser beam to be reflected through a reticle 116. A projection lens 118 allows patterns on reticle 116 to be projected onto a surface of a wafer 120 when a laser beam passes through reticle 116. As will be understood by those skilled in the art, reticle 116 is typically supported on a reticle stage (not shown), while wafer 120 is typically supported on a wafer stage (not shown).

Illumination unit 112 is shown in more detail in FIG. 2, which is a cross-sectional representation of illumination unit 112 in accordance with an embodiment of the present invention. Although illumination unit 112 may include multiple components such as mirrors and lenses, many components of illumination unit 112 are not shown for ease of illustration. Illumination unit 112, in addition to including mirror 114, includes a lens unit 210 through which a laser beam 202 or other light passes. Lens unit 210 may be any type of lens, e.g., lens 210 may be a fly's eye lens. Once laser beam 202 passes through lens 210, beam may pass through a changeable slit 211 or illuminating aperture defined between slit plates 216a, 216b. The position of changeable slit 211 may vary within an illumination focus plane.

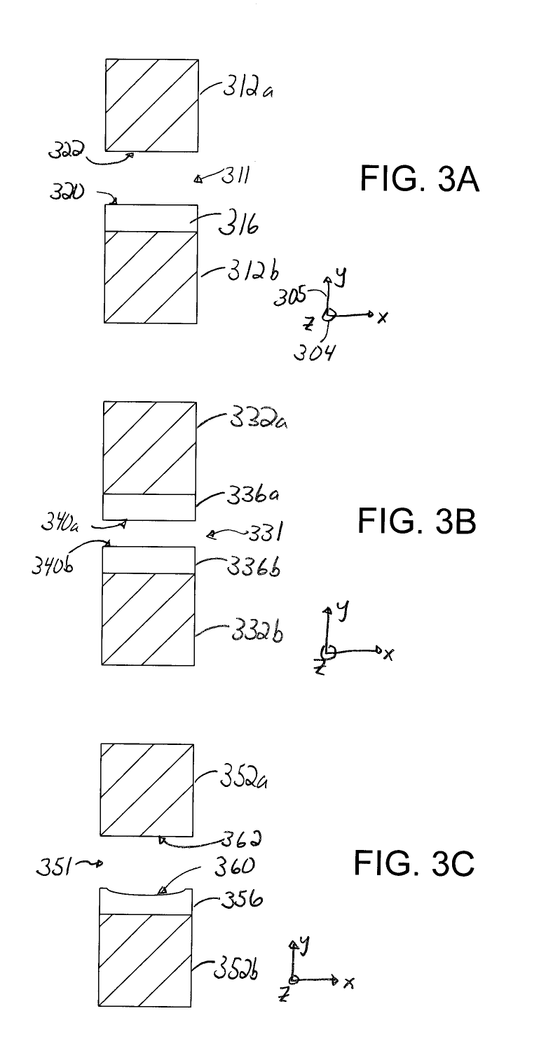

Slit plates 216a, 216b may be removably supported on structures 212a, 212b. Structures 212a, 212b may be considered to be support surfaces, and may include slit plate holders (not shown) that are arranged to allow slit plates 216a, 216b to be readily removed and installed. In one embodiment, structures 212a, 212b are arranged to define a slit when slit plates 216a, 216b are not in place. It should be understood that although two slit plates 216a, 216b are shown, illumination unit 112 may include any number of slit plates, as for example a single slit plate. When only slit plate 216b is included in illumination unit 112, slit 211 may be defined by an edge of the single slit plate 216b and by an edge of structure 212a. Alternatively, when only slit plate 216a is included, slit 211 may be defined by slit plate 216a and an edge of structure 212b. Slit plates 216a, 216b will be described below with reference to FIGS. 3A-3C.

Slit 211 is generally positioned in close proximity to a reticle blind 214. By way of example, slit 211 may be located approximately 1 or 2 millimeters (mm) from reticle blind 214, within an illumination focus plane. Although slit 211 is shown as being located between reticle blind 214 and lens 219, it should be appreciated that slit 211 may instead be positioned between reticle blind 214 and mirror 114. Reticle blind 214, when closed, may prevent laser 202 from reaching mirror 114 and, hence, a reticle (not shown). When open, reticle blind 214 does not affect the path of laser 202. Hence, laser 202 may pass through slit 211 to mirror 114.

As previously mentioned, the number of slit plates 212a, 212b in illumination unit 112 may vary. FIG. 3A is a diagrammatic representation of a slit that is defined using a removable slit plate and an edge of a fixed structure in accordance with an embodiment of the present invention. A slit 311 is defined such that a laser or light (not shown) may pass therethrough in a z-direction 304. That is, a laser or light (not shown) that has a path in z-direction 304 may pass through slit 311.

Slit 311 is defined by a first edge 322 and a second edge 320. First edge 322 is an edge of a first support surface 312a and second edge 320 is an edge of a removable slit plate 316 that is removably attached to a second support surface 312b. Although removable slit plate 316 is shown as being coupled to second support surface 312b, removable slit plate 316 may instead be coupled to first support surface 312a. In one embodiment, removable slit plate 316 is coupled to whichever support surface 312a, 312b is more easily accessed, e.g., by an operator who intends to replace removable slit plate 316. As will be understood by those skilled in the art, support surfaces 312a, 312b themselves may define a slit when removable slit plate 316 is not present.

Removable slit plate 316 blocks a laser or light (not shown) in a y-direction 305. That is, removable slit plate 316 constrains the passage of a laser relative to y-direction 305. While removable slit plate 316 is shown as being polygonal, e.g., rectangular, in shape, the shape of removable slit plate 316 may vary widely, as will be described below with respect to FIG. 3C.

In lieu of removable slit plate 316 and first support surface 312a cooperating to define edges of slit 311, a pair of substantially opposing slit plates may instead be used to define a slit. FIG. 3B is a diagrammatic representation of a slit that is defined using a plurality of removable slit plates in accordance with an embodiment of the present invention. Support surfaces 332a, 332b support removable slit plates 336a, 336b, respectively. An edge 340a of a first removable slit plate 336a and an edge 340b of a second removable slit plate 336b define opposing edges of a slit 331. Although both removable slit plates 336a, 336b may be removed and replace to redefine slit 331, slit 331 may also be redefined by removing and replacing only one of removable slit plates 336a, 336b.

As mentioned above, the size and shape of a removable slit plate may vary widely. By varying the size or the shape of a slit, the illumination uniformity associated with an exposure of a wafer through the slit may be varied. Generally, the size and the shape of a slit may be varied by varying the size and the shape of a removable slit plate. With reference to FIG. 3C, a removable slit plate with a concave edge will be described in accordance with an embodiment of the present invention. A removable slit plate 356, which is coupled to a support surface 352a, has an edge 360 that cooperates with an edge 362 of a support surface 352a to define a slit 351. As shown, edge 360 has an approximately concave shape. Hence, slit 351 effectively has a convex, curved edge.

The amount of curvature in edge 360 may vary widely. Further, the shape of edge 360 may also vary. By way of example, edge 360 may have shapes including, but not limited to, a convex shape, a shape that is suitable for compensating for an “X-tilt,” and an s-curve shape.

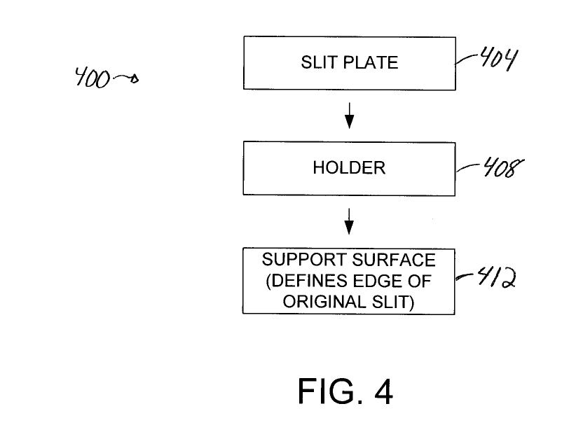

In order for a slit plate to be removable, a slit plate is removably coupled to a slit plate holder. The coupling between a slit plate and a slit plate holder may entail screwing the slit plate into the slit plate holder, press-fitting the slit plate into the slit plate holder, or otherwise relatively securely fastening the slit plate to the slit plate holder, e.g., through the use of magnets. A slit plate holder, or a receptacle for a slit plate, may be securely coupled to a support surface. The support surface may be a surface which is suitable for use in defining a slit when a slit plate is not present. FIG. 4 is a block diagram representation of an assembly that includes a slit plate and a slit plate holder in accordance with an embodiment of the present invention. An assembly 400 includes a support surface 412, a slit plate holder 408, and a removable slit plate 404. Slit plate holder 408 may be fastened to, or otherwise formed as an integral part of, support surface 412. Removable slit plate 404 is arranged to be coupled to slit plate holder 408.

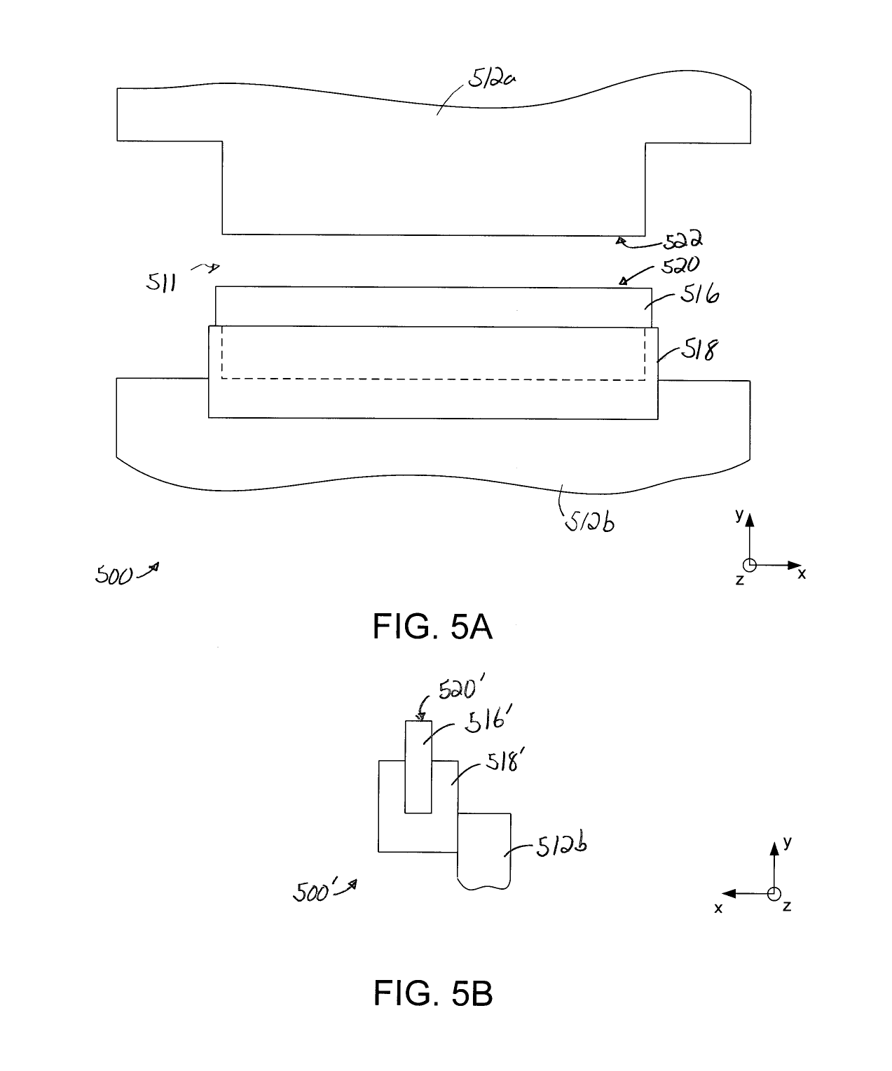

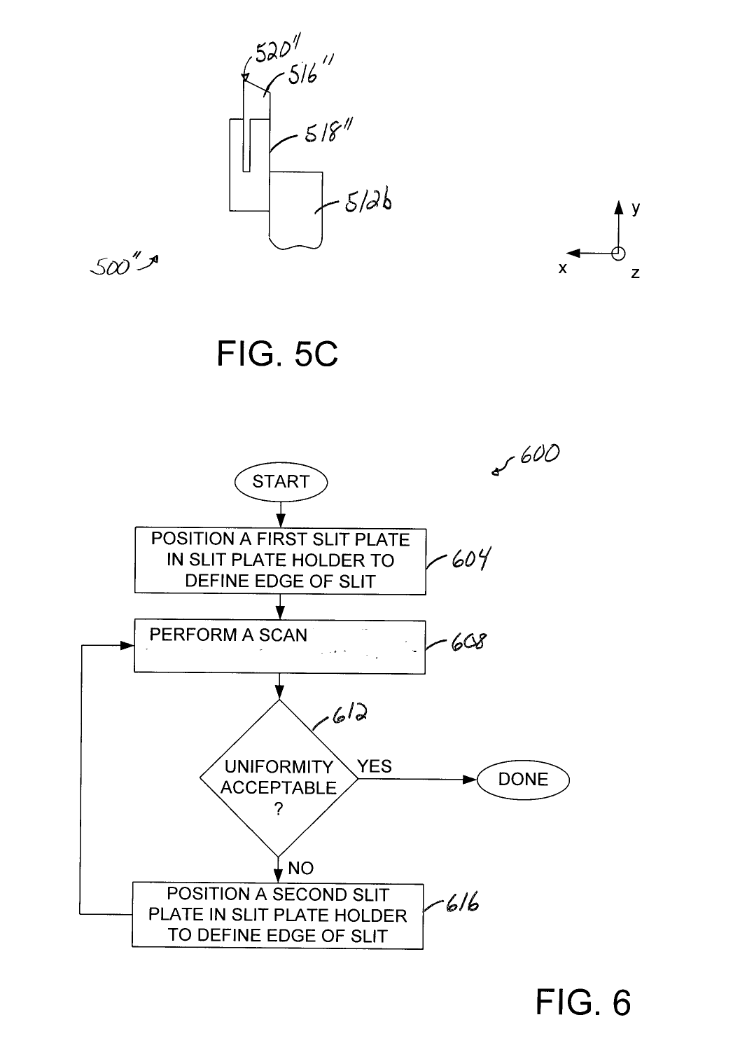

FIG. 5A is a diagrammatic front-view representation of an assembly that includes a single removable slit plate in accordance with an embodiment of the present invention. An assembly 500 includes a first support surface 512a with a first edge 522. First edge 522, in cooperation with an edge 520 of a removable slit plate 516, defines edges of a slit 511. Removable slit plate 516 is inserted into and coupled to a slit plate holder 518 that is mounted on a second support surface 512b. Magnets may be utilized to facilitate the coupling of removable slit plate 516 to slit plate holder 518. Magnets coupled to removable slit plate 516 may enable removable slit plate 516 to be secured into position relative to slit plate holder 518. It should be appreciated that in the absence of removable slit plate 516, a top edge of slit plate holder 518 may cooperate with first edge 522 to define a slit.

Slit plate holder 518 may be made from any suitable material. In one embodiment, slit plate holder 518 is formed from a metal such as nickel, as nickel has magnetic properties that allow magnets to be used to facilitate the positioning of removable slit plate 516 relative to slit plate holder 518. Similarly, removable slit plate 516 may also be formed from any suitable material, e.g., anodized aluminum.

The size and the shape of both removable slit plate 516 and slit plate holder 518 may vary. FIG. 5B is a diagrammatic cross-sectional side view representation of one embodiment of removable slit plate 516 and slit plate holder 518 in accordance with an embodiment of the present invention. An assembly 500′ may include a slit plate holder 518′ that has a receptacle into which a removable slit plate 516′ with a slit-defining edge 520′ is inserted. As shown, removable slit plate 516′ has an approximately rectangular cross-section. Alternatively, as shown in FIG. 5C, which is a diagrammatic cross-sectional side view representation of another embodiment of removable slit plate 516 and slit plate holder 518, an assembly 500″ may include a removable slit plate 516″ with an irregular cross-section that is inserted into a slit plate holder 518″ that is arranged to accommodate removable slit plate 516″. An edge 520″ is a slit-defining edge.

FIG. 6 is a process flow diagram which illustrates steps associated with one method of utilizing a changeable slit that is at least partially defined by a removable slit plate in accordance with an embodiment of the present invention. A process 600 of utilizing a changeable slit begins at step 604 in which a first slit plate is positioned in a slit plate holder. The first slit plate includes a surface that defines an edge of a slit. Positioning a first slit plate in a slit plate holder, e.g., a slit plate holder that is coupled to or otherwise incorporated into a support surface, may include screwing or otherwise securing the first slit plate in the slit plate holder.

Once the first slit plate is positioned, a scan is performed in step 608. The scan is performed while the slit allows some light to be passed therethrough to an exposure field. The size and the shape of the slit impacts the illumination uniformity associated with the scan. For example, the illumination uniformity of a substantially straight-edged slit may differ from the illumination uniformity of a slit which has a convex, a concave, or an “X tilt” shape.

A determination is made in step 612 as to whether the illumination uniformity associated with the scan is acceptable. That is, it is determined if the first slit plate is to be replaced by a slit plate which may be suitable for providing a desired illumination uniformity. While methods used to determine whether illumination uniformity is acceptable may vary, such methods typically involve measuring the dynamic uniformity associated with a scan. If it is determined in step 612 that the illumination uniformity associated with the scan is acceptable, the process of utilizing a changeable slit is completed. Alternatively, if the determination is that the illumination uniformity is not acceptable, the indication is that at least one of the size and the shape of the slit may be changed. Accordingly, in step 616, a second slit plate replaces the first slit plate. In other words, the first slit plate is removed and the second slit plate is positioned in the slit plate holder to define an edge of a slit. Typically, the second slit plate is arranged to change the outline of the slit. After the second slit plate is positioned in the slit plate holder, process flow returns to step 608 in which a scan is performed.

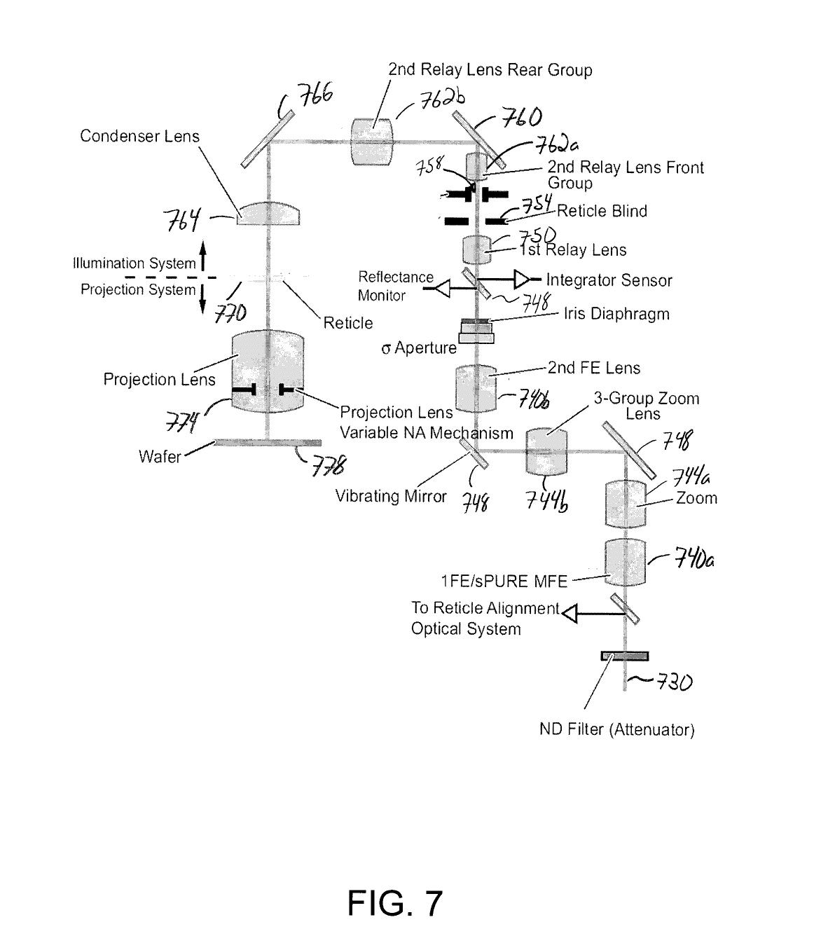

An illumination path of a beam through a lithography system has generally been described as passing through a lens to a changeable slit before reaching a reticle. However, an illumination path may pass through or be reflected off of a number of other components. Many scanners may have associated illumination paths that pass through multiple lenses and are reflected off of multiple mirrors. Referring next to FIG. 7, the illumination path of a beam through one example of a lithography system will be described in accordance with an embodiment of the present invention. An illumination path 730 passes through a filter 730, as well as a plurality of mirrors 748, a plurality of fly's eye lenses 740a, 740b, and a plurality of zoom lenses 744a, 744b. Eventually, illumination path 730 passes through a first relay lens 750 and a reticle blind 754, when reticle blind 754 is open. Once illumination path 730 passes through reticle blind 754, illumination path 730 may pass through a changeable slit 758 that has an edge that is defined by a removable slit plate (not shown). Although illumination path 730 is shown as passing through reticle blind 754 prior to passing through changeable slit 758, it should be appreciated that the position of changeable slit 758 relative to reticle blind 754 may vary.

After passing through changeable slit 758, illumination path 730 passes through a relay lens first group 762a, and is reflected off of a mirror 760. Once reflected off of mirror 760, illumination path 730 passes through a relay lens second group 762b, and is reflected off of mirror 766 and through a condenser lens 764 to a reticle 770. Reticle 770 allows some light in illumination path 730 to pass through a projection lens assembly 774 and onto a surface of a wafer 778.

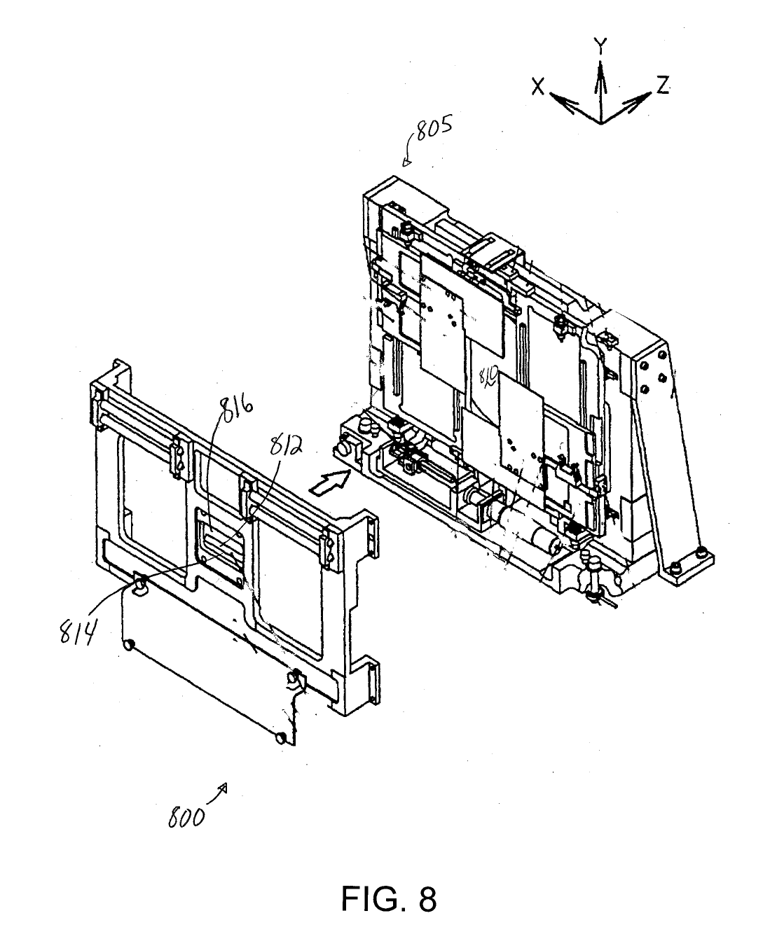

As mentioned above, a changeable slit may be positioned in proximity to a reticle blind. FIG. 8 is a diagrammatic representation of a support structure that includes a changeable slit and is positioned in proximity to an open reticle blind in accordance with an embodiment of the present invention. A support structure 800 has a changeable or adjustable slit 812 defined therethrough. Support structure 800 is positioned relative to a reticle blind arrangement 805 such that a beam (not shown) that first passes through changeable slit 812 also passes through an opening 810 in reticle blind arrangement 805. Alternatively, support structure 800 may be positioned such that a beam (not shown) that passes through opening 810 then passes through changeable slit 812.

Changeable slit 812 is defined by a removable slit plate 814 and a slit plate 816. Slit plate 816 may either be a removable slit plate or a fixed slit plate. Removable slit plate 814 is supported by a slit plate holder (not shown) that is mounted in support structure 800. It should be appreciated that support structure 800 is one example of a support structure which may support a removable slit plate. The configuration of a support structure may generally be widely varied.

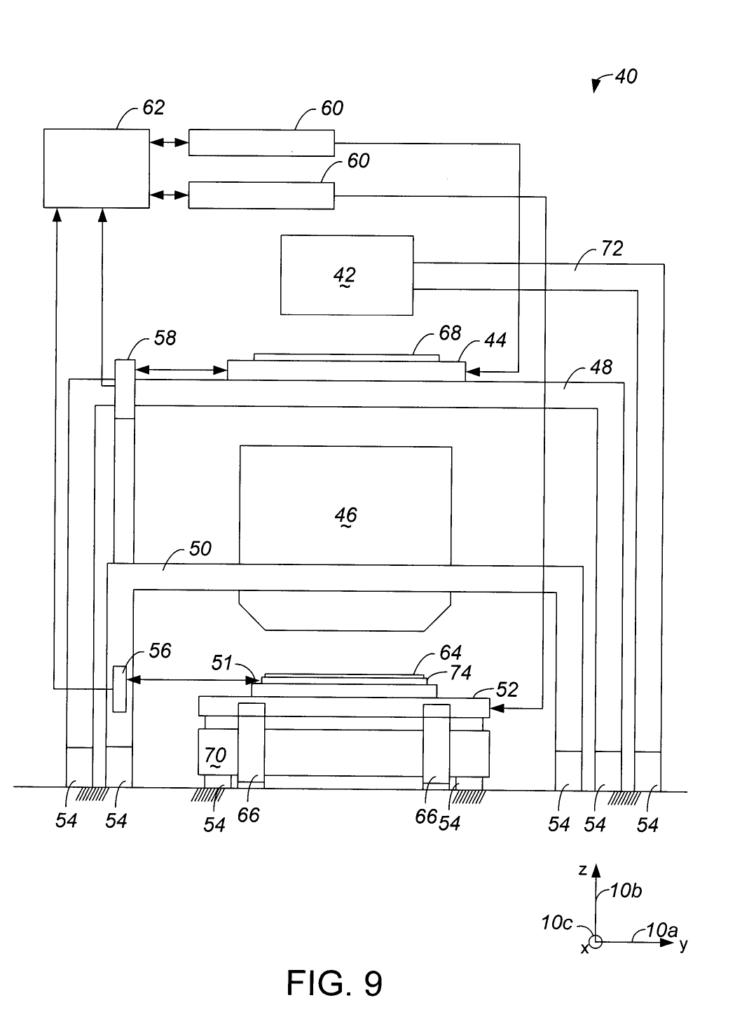

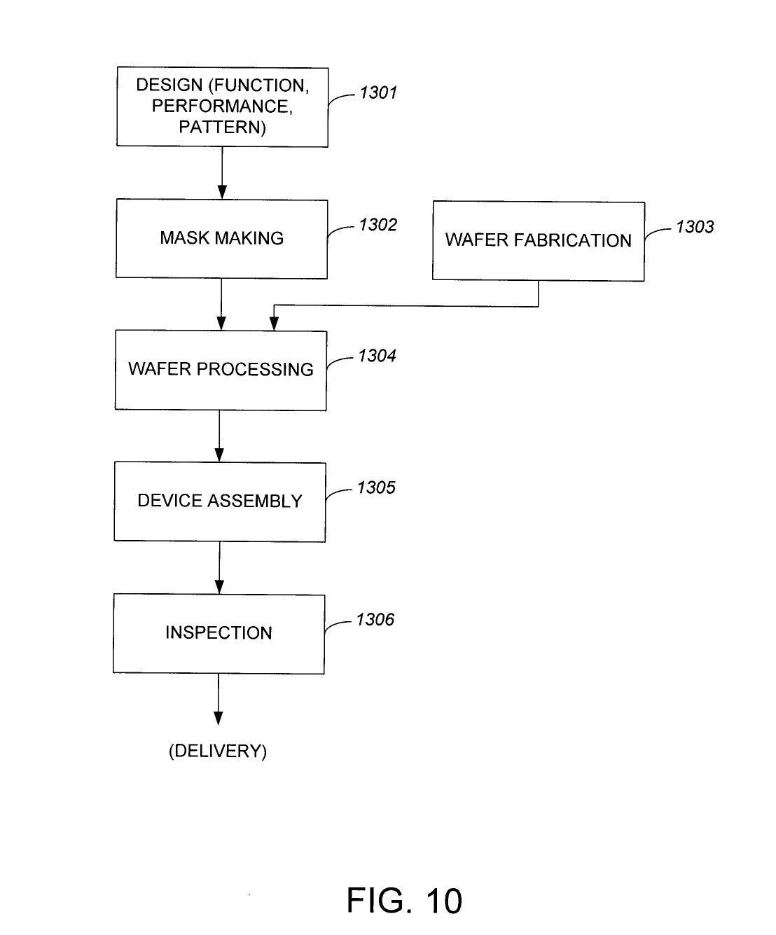

With reference to FIG. 9, a photolithography apparatus which may utilize an illumination system with a changeable slit arrangement, e.g., at least one removable slit plate, will be described in accordance with an embodiment of the present invention. It should be appreciated that while the photolithography apparatus of FIG. 9 is only one example of a photolithography apparatus that may utilize a changeable slit arrangement. Other photolithography apparatus, as for example a photolithography apparatus used for extreme ultraviolet lithography, may also use a changeable or variable slit arrangement. A photolithography apparatus (exposure apparatus) 40 includes a wafer positioning stage 52 that may be driven by linear or a planar motors (not shown), as well as a wafer table 51 that is magnetically coupled to wafer positioning stage 52 by utilizing an EI-core actuator. The planar motor which drives or motors which drive wafer positioning stage 52 generally utilizes an electromagnetic force generated by magnets and corresponding armature coils arranged in two dimensions. A wafer 64 is held in place on a wafer holder or chuck 74 which is coupled to wafer table 51. Wafer positioning stage 52 is arranged to move in multiple degrees of freedom, e.g., between three to six degrees of freedom, under the control of a control unit 60 and a system controller 62. In one embodiment, wafer positioning stage 52 may include a plurality of actuators which are coupled to a common magnet track. The movement of wafer positioning stage 52 allows wafer 64 to be positioned at a desired position and orientation relative to a projection optical system 46.

Wafer table 51 may be levitated in a z-direction 10b by any number of voice coil motors VCMs (not shown), e.g., three voice coil motors. Wafer table 51 may be supported in z-direction 10b by an anti-gravity device. In one embodiment, at least three magnetic bearings (not shown) couple and move wafer table 51 along a y-axis 10a. The motor array of wafer positioning stage 52 is typically supported by a base 70. Base 70 is supported to a ground via isolators 54. Reaction forces generated by motion of wafer stage 52 may be mechanically released to a ground surface through a frame 66. One suitable frame 66 is described in JP Hei 8-166475 and U.S. Pat. No. 5,528,118, which are each herein incorporated by reference in their entireties.

An illumination system 42 is supported by a frame 72. Illumination system 42 may generally include a reticle blind, e.g., either a horizontal reticle blind or a vertical reticle blind, and a variable slit arrangement. Frame 72 is supported to the ground via isolators 54. Frame 72 may be part of a lens mount system of illumination system 42, and may be coupled to an active damper (not shown) which damps vibrations in frame 72 and, hence, illumination system 42. Illumination system 42 includes an illumination source, and is arranged to project a radiant energy, e.g., light, through a mask pattern on a reticle 68 that is supported by and scanned using a reticle stage 44 which includes a coarse stage and a fine stage. Either or both coarse stage and fine stage may be a monolithic reticle stage with up to six degrees of freedom. The radiant energy is focused through projection optical system 46, which is supported on a projection optics frame 50 and may be supported the ground through isolators 54. In one embodiment, projection optics frame 50 is coupled to an active damper (not shown) that is arranged to apply a variable force through a load point of projection optics frame in order to compensate for vibrational modes associated with projection optics frame 50. Suitable isolators 54 include those described in JP Hei 8-330224 and U.S. Pat. No. 5,874,820, which are each incorporated herein by reference in their entireties.

A first interferometer 56 is supported on projection optics frame 50, and functions to detect the position of wafer table 51. Interferometer 56 outputs information on the position of wafer table 51 to system controller 62. In one embodiment, wafer table 51 has a force damper which reduces vibrations associated with wafer table 51 such that interferometer 56 may accurately detect the position of wafer table 51. A second interferometer 58 is supported on projection optical system 46 optics frame 50, and detects the position of reticle stage 44 which supports a reticle 68. Interferometer 58 also outputs position information to system controller 62.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer positioning stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary, i.e., at a substantially constant velocity of approximately zero meters per second. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head.

The illumination source of illumination system 42 may be g-line (436 nanometers (nm)), i-line (365 nm), a KrF excimer laser (248 nm), an ArF excimer laser (193 nm), and an F₂-type laser (157 nm). Alternatively, illumination system 42 may also use charged particle beams such as x-ray and electron beams. For instance, in the case where an electron beam is used, thermionic emission type lanthanum hexaboride (LaB₆) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser is used, glass materials such as quartz and fluorite that transmit far ultra-violet rays is preferably used. When either an F₂-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave mirror. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave mirror, but without a beam splitter, and may also be suitable for use with the present invention.

The present invention may be utilized, in one embodiment, in an immersion type exposure apparatus if suitable measures are taken to accommodate a fluid. For example, PCT patent application WO 99/49504, which is incorporated herein by reference in its entirety, describes an exposure apparatus in which a liquid is supplied to a space between a substrate (wafer) and a projection lens system during an exposure process. Aspects of PCT patent application WO 99/49504 may be used to accommodate fluid relative to the present invention.

Further, the present invention may be utilized in an exposure apparatus that comprises two or more substrate and/or reticle stages. In such an apparatus, e.g., an apparatus with two substrate stages, one substrate stage may be used in parallel or preparatory steps while the other substrate stage is utilizes for exposing. Such a multiple stage exposure apparatus is described, for example, in Japan patent Application Disclosure No. 10-163099, as well as in Japan patent Application Disclosure No. 10-214783 and its U.S. counterparts, namely U.S. Pat. No. 6,341,007, U.S. Pat. No. 6,400,441, U.S. Pat. No. 6,549,269, U.S. Pat. No. 6,590,634. Each of these Japan patent Application Disclosures and U.S. patents are incorporated herein by reference in their entireties. A multiple stage exposure apparatus is also described in Japan patent Application Disclosure No. 20000-505958 and its counterparts U.S. Pat. No. 5,969,441 and U.S. Pat. No. 6,208,407, each of which are incorporated herein by reference in their entireties.

The present invention may be utilized in an exposure apparatus that has a movable stage that retains a substrate (wafer) for exposure, as well as a stage having various sensors or measurement tools, as described in Japan patent Application Disclosure No. 11-135400, which is incorporated herein by reference in its entirety. In addition, the present invention may be utilized in an exposure apparatus that is operated in a vacuum environment such as an EB type exposure apparatus and an EUVL type exposure apparatus when suitable measures are incorporated to accommodate the vacuum environment for air (fluid) bearing arrangements.

Further, in photolithography systems, when linear motors (see U.S. Pat. No. 5,623,853 or 5,528,118, which are each incorporated herein by reference in their entireties) are used in a wafer stage or a reticle stage, the linear motors may be either an air levitation type that employs air bearings or a magnetic levitation type that uses Lorentz forces or reactance forces. Additionally, the stage may also move along a guide, or may be a guideless type stage which uses no guide.

Alternatively, a wafer stage or a reticle stage may be driven by a planar motor which drives a stage through the use of electromagnetic forces generated by a magnet unit that has magnets arranged in two dimensions and an armature coil unit that has coil in facing positions in two dimensions. With this type of drive system, one of the magnet unit or the armature coil unit is connected to the stage, while the other is mounted on the moving plane side of the stage.

Movement of the stages as described above generates reaction forces which may affect performance of an overall photolithography system. Reaction forces generated by the wafer (substrate) stage motion may be mechanically released to the floor or ground by use of a frame member as described above, as well as in U.S. Pat. No. 5,528,118 and published Japanese Patent Application Disclosure No. 8-166475. Additionally, reaction forces generated by the reticle (mask) stage motion may be mechanically released to the floor (ground) by use of a frame member as described in U.S. Pat. No. 5,874,820 and published Japanese Patent Application Disclosure No. 8-330224, which are each incorporated herein by reference in their entireties.

Isolaters such as isolators 54 may generally be associated with an active vibration isolation system (AVIS). An AVIS generally controls vibrations associated with forces 112, i.e., vibrational forces, which are experienced by a stage assembly or, more generally, by a photolithography machine such as photolithography apparatus 40 which includes a stage assembly.

A photolithography system according to the above-described embodiments may be built by assembling various subsystems in such a manner that prescribed mechanical accuracy, electrical accuracy, and optical accuracy are maintained. In order to maintain the various accuracies, prior to and following assembly, substantially every optical system may be adjusted to achieve its optical accuracy. Similarly, substantially every mechanical system and substantially every electrical system may be adjusted to achieve their respective desired mechanical and electrical accuracies. The process of assembling each subsystem into a photolithography system includes, but is not limited to, developing mechanical interfaces, electrical circuit wiring connections, and air pressure plumbing connections between each subsystem. There is also a process where each subsystem is assembled prior to assembling a photolithography system from the various subsystems. Once a photolithography system is assembled using the various subsystems, an overall adjustment is generally performed to ensure that substantially every desired accuracy is maintained within the overall photolithography system. Additionally, it may be desirable to manufacture an exposure system in a clean room where the temperature and humidity are controlled.

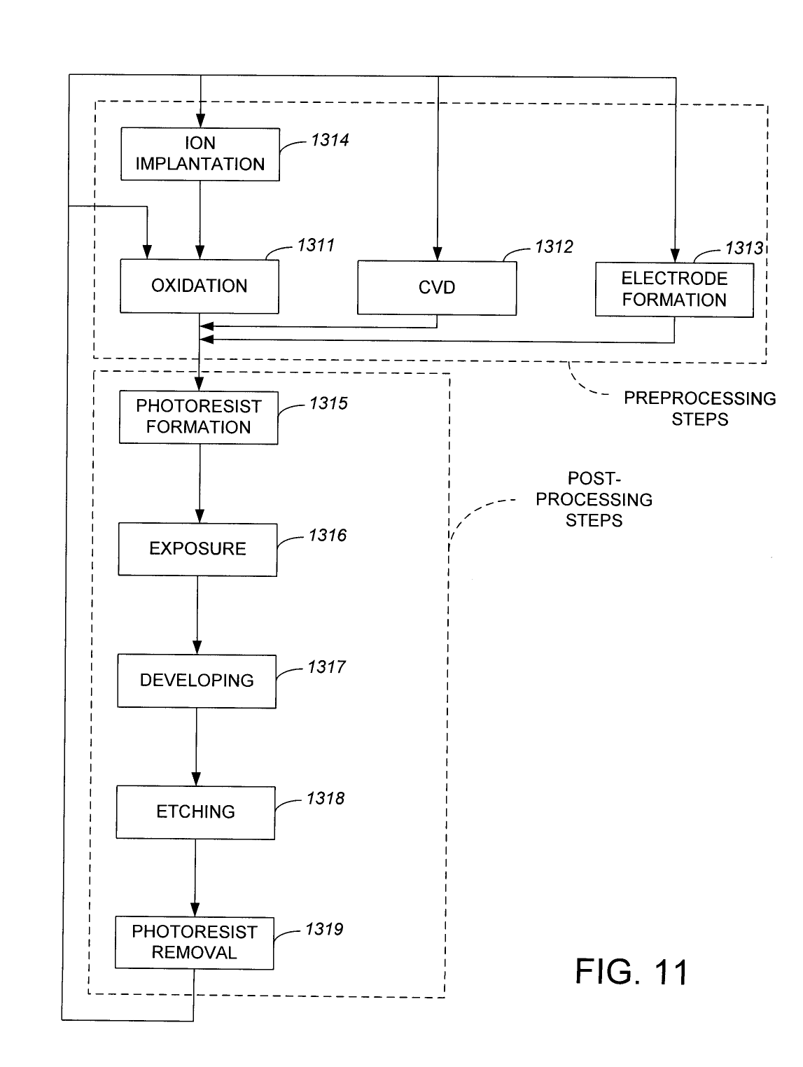

Further, semiconductor devices may be fabricated using systems described above, as will be discussed with reference to FIG. 10. The process begins at step 1301 in which the function and performance characteristics of a semiconductor device are designed or otherwise determined. Next, in step 1302, a reticle (mask) in which has a pattern is designed based upon the design of the semiconductor device. It should be appreciated that in a parallel step 1303, a wafer is made from a silicon material. The mask pattern designed in step 1302 is exposed onto the wafer fabricated in step 1303 in step 1304 by a photolithography system. One process of exposing a mask pattern onto a wafer will be described below with respect to FIG. 11. In step 1305, the semiconductor device is assembled. The assembly of the semiconductor device generally includes, but is not limited to, wafer dicing processes, bonding processes, and packaging processes. Finally, the completed device is inspected in step 1306.

FIG. 11 is a process flow diagram which illustrates the steps associated with wafer processing in the case of fabricating semiconductor devices in accordance with an embodiment of the present invention. In step 1311, the surface of a wafer is oxidized. Then, in step 1312 which is a chemical vapor deposition (CVD) step, an insulation film may be formed on the wafer surface. Once the insulation film is formed, in step 1313, electrodes are formed on the wafer by vapor deposition. Then, ions may be implanted in the wafer using substantially any suitable method in step 1314. As will be appreciated by those skilled in the art, steps 1311-1314 are generally considered to be preprocessing steps for wafers during wafer processing. Further, it should be understood that selections made in each step, e.g., the concentration of various chemicals to use in forming an insulation film in step 1312, may be made based upon processing requirements.

At each stage of wafer processing, when preprocessing steps have been completed, post-processing steps may be implemented. During post-processing, initially, in step 1315, photoresist is applied to a wafer. Then, in step 1316, an exposure device may be used to transfer the circuit pattern of a reticle to a wafer. Transferring the circuit pattern of the reticle of the wafer generally includes scanning a reticle scanning stage which may, in one embodiment, include a force damper to dampen vibrations. It should be appreciated that when the circuit pattern of the reticle is transferred to the wafer, an automatic reticle blind is generally in an open position to allow a laser beam to pass therethrough.

After the circuit pattern on a reticle is transferred to a wafer, the exposed wafer is developed in step 1317. Once the exposed wafer is developed, parts other than residual photoresist, e.g., the exposed material surface, may be removed by etching. Finally, in step 1319, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. By way of example, while the use of one or two removable slit plates that each have an outside edge that forms an edge of a slit has been described, the number of removable slit plates used to form at least one edge of a slit may vary widely. In some instances, a bottom of a slit may be defined by more than one removable slit plate.

A changeable slit that is defined by at least one slit plate may be incorporated into substantially any system in which the passage of a beam, e.g., a beam of light, to an exposure surface occurs through a slit. That is, a changeable slit is not limited for use in an illumination unit of a lithography apparatus such as a scanner.

A removable slit plate may generally be provided to and retrieved from a support apparatus using any suitable method. In one embodiment, a removable slit plate may include a feature that facilitates coupling and decoupling the removable slit plate from a support apparatus. For instance, a removable slit plate may have a screw hole tapped therein that allows a tool that provides or retrieves the removable slit plate to or from a location to be attached.

The steps associated with utilizing a removable slit plate may vary widely. Steps may be altered, added, removed, or reordered without departing from the spirit or the scope of the present invention. Therefore, the present examples are to be considered as illustrative and not restrictive, and the invention is not to be limited to the details given herein, but may be modified within the scope of the appended claims.

The invention claimed is:

1. An apparatus comprising:
a light source, the light source being arranged to generate a beam;
an exposure surface, wherein the beam is arranged to be projected onto the exposure surface; and
an illumination arrangement, the illumination arrangement including a first support surface and a first removable plate arranged to be coupled to the first support surface, the illumination arrangement further including a first edge and a second edge, the first edge being a part of the first removable plate, wherein the first edge and the second edge cooperate to at least partially define a slit through which the beam is arranged to be projected.

2. The apparatus of claim 1 wherein the illumination arrangement further includes a second support surface, the second edge being a part of the second support surface.

3. The apparatus of claim 1 wherein the illumination arrangement further includes a second support surface and a second removable plate, the second edge being a part of the second removable plate.

4. The apparatus of claim 1 wherein the illumination arrangement includes a lens and a mirror, the slit being arranged between the lens and the mirror.

5. The apparatus of claim 4 further including a reticle blind, the reticle blind being arranged between the slit and the lens.

6. The apparatus of claim 1 wherein the first support surface has an associated slit receptacle, and the first removable plate is arranged to be coupled to the first support surface through the associated slit receptacle.

7. The apparatus of claim 1 wherein the first edge has a curved shape.

8. The apparatus of claim 1 wherein the first edge is a straight edge.

9. The apparatus of claim 1 wherein the apparatus is a scanner.

10. An exposure apparatus comprising the scanner of claim 9.

11. A device manufactured with the exposure apparatus of claim 10.

12. A wafer on which an image has been formed by the exposure apparatus of claim 10.

13. A method for controlling illumination uniformity associated with a scanning apparatus, the scanning apparatus including a first support surface and a second support surface, the scanning apparatus further including a source and an exposure surface, the method comprising:
coupling a first removable slit plate to the first support surface, the first removable slit plate having a first edge, wherein the first edge cooperates with a second edge of the second support surface to define a slit;
performing a scan, wherein performing a scan includes creating a beam using the source, wherein the beam passes through the slit to the exposure surface;
determining if illumination uniformity associated with the scan is acceptable;
removing the first removable slit plate from the first support surface if it is determined that the illumination uniformity associated with the scan is not acceptable; and
coupling a second removable slit plate to the first support surface after removing the first removable slit plate from the first support surface, the second removable slit plate having a third edge, wherein the third edge cooperates with the second edge to define the slit.

14. The method of claim 13 wherein the scanning apparatus includes a slit plate holder, the slit plate holder being supported by the first support surface, the slit plate holder being arranged to couple the first removable slit plate to the first support surface and to couple the second removable slit plate to the first support surface if the first removable slit plate is removed.

15. The method of claim 13 wherein coupling the first removable slit plate to the first support surface includes magnetically coupling the first removable slit plate to the first support surface.

16. The method of claim 13 wherein the first edge is one selected from the group including an edge with a convex shape, an edge with a concave shape, an edge with a straight shape, and an edge with an s-curve shape.

17. A method for operating an exposure apparatus comprising the method for controlling illumination uniformity of claim 13.

18. A method for making an object including at least a photolithography process, wherein the photolithography process utilizes the method of operating an exposure apparatus of claim 17.

19. A method for making a wafer utilizing the method of operating an exposure apparatus of claim 17.

20. A method for controlling illumination uniformity associated with a scanning apparatus, the scanning apparatus including a first support surface and a second support surface, the scanning apparatus further including a source and an exposure surface, the method comprising:
coupling a first removable slit plate to the first support surface, the first removable slit plate having a first edge;
coupling a second removable slit plate to the second support surface, the second removable slit plate having a second edge, wherein the first edge cooperates with a second edge to define a slit;
performing a scan, wherein performing a scan includes creating a beam using the source, wherein the beam passes through the slit to the exposure surface;
determining if illumination uniformity associated with the scan is acceptable;
removing the first removable slit plate from the first support surface if it is determined that the illumination uniformity associated with the scan is not acceptable; and
coupling a third removable slit plate to the first support surface after removing the first removable slit plate from the first support surface, the third removable slit plate having a third edge, wherein the third edge cooperates with the second edge to define the slit.
